(19) United States
(12) Patent Application Publication
(10) Pub. No.: US 2007/0097417 A1
(43) Pub. Date: May 3, 2007

(54) Print control process device

(76) Inventors: Yukio Shibata, Osaka (JP); Kenji Kimura, Yamatokoriyama (JP)

Correspondence Address: GLOBAL IP COUNSELORS, LLP, 1233 20TH STREET, NW, SUITE 700, WASHINGTON, DC, 20036-2680, US

(21) Appl. No.: 11/258,871

(22) Filed: Oct. 27, 2005

(51) Int. Cl. G06F 3/12

(52) U.S. Cl. 358/1.15

(57) ABSTRACT

Icons 31 and 32, for specifying each of at least two kinds of printing means, are displayed on a toolbar 30 of a display screen of a display unit 25, and in response to one of the icons having been designated, a corresponding printing means is controlled with a corresponding driving program, thereby enabling printing of the desired data by selecting any printing means in a simple operation, for instance, when carrying out monochrome printing, color printing or the like.

### FIELD OF THE INVENTION

This invention relates to a print control process device; in particular, it relates to a print control process device that enables a desired printing by selecting any of a plurality of printers.

### BACKGROUND INFORMATION

In recent years, with the spread of network devices, multiple personal computers (hereinafter abbreviated as PC) and printers are connected over a network. When a user prints the desired information using any PC, the user specifies a predetermined printer to carry out the printing, taking into account whether the document is a monochrome document or a color document, which printer is free, and the like.

Print instruction devices are known in prior art, which allow print setting to be carried out easily according to the nature of the information source.

When an application screen is launched on a PC screen, a symbol for the printer is displayed on the toolbar to simplify the setting for printing with the printer, which is set up in such a way that the data of the application currently open on the PC is printed immediately when this display is clicked with a mouse. However, the printer displayed on the toolbar is set up in such a way that the printer model and the number of copies are set beforehand, and only one printer can be set.

However, printers with different applications such as color printers and high speed printers are connected on the network in addition to monochrome printers, and for instance, while monochrome printing is immediately possible if printing with a monochrome printer has been set and the toolbar is clicked, there is a complication when attempting to print with a color printer, as a print setting screen must be called and a keyboard and a mouse be operated to redo the printer setting, each time.

In addition, for instance, if the printer that is to print cannot print due to a difference in the size of the paper, it is difficult for the user to know this fact, giving rise to inconveniences such as having to call the print setting screen again to redo the setting.

Therefore, an object of this invention is to provide a print control process device that enables printing by selecting from a plurality of printers with a simple operation.

### SUMMARY OF THE INVENTION

This invention is a print control process device for enabling printing by selecting from at least two kinds of printing means, comprising a display means and a control means having built therein driving programs corresponding to each of the at least two kinds of printing means, for displaying on a display screen of the display means identification labels that specify each of the at least two kinds of printing means, and in response to one of the identification labels having been designated, controling the corresponding printing means with the corresponding driving program.

Preferably, the control means verifies whether printing by the at least two kinds of printing means is possible, and displays only the identification label corresponding to the printing means that has been verified to be able to print. A more specific example is to display a print icon on the toolbar of the display screen of the display means as an identification label.

Preferably, the at least two kinds of printing means include printing means enabling color printing and monochrome printing, or printing means with different printing speeds.

In this invention, identification labels for specifying each of at least two kinds of printing means are displayed on the display screen, and in response to one of the identification labels having been designated, the corresponding printing means is controlled with the corresponding driving program; thus, printing of the desired data is possible by selecting any printing means with a simple operation, for instance, when carrying out monochrome printing, color printing and the like.

### BRIEF DESCRIPTION OF THE DRAWINGS

FIG. 1 is a block diagram of a print control process device according to one embodiment of this invention.

FIG. 2 is a block diagram of a PC shown in FIG. 1.

FIG. 3 is a flowchart to explain the working of one embodiment of this invention.

FIG. 4 is a view showing a display screen of a display unit shown in FIG. 2.

### DETAILED DESCRIPTION OF THE PREFERRED EMBODIMENTS

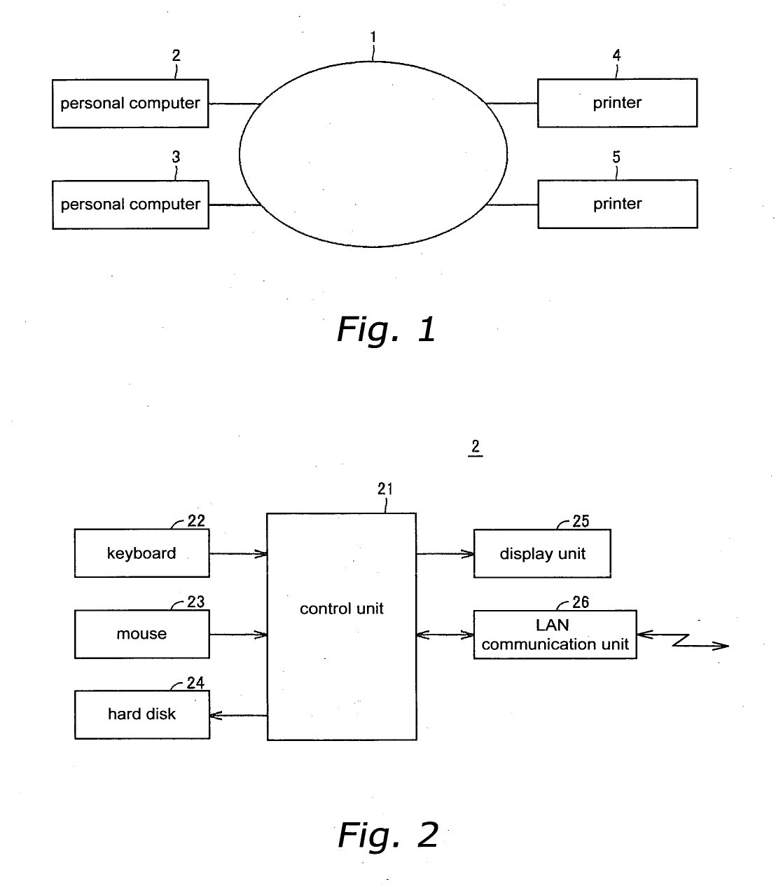

FIG. 1 is a block diagram of a print control process device according to one embodiment of this invention, and FIG. 2 is a block diagram of a PC shown in FIG. 1. In FIG. 1, for instance, two PCs 2 and 3, and two printers 4 and 5 as printing means, are connected to a LAN (Local Area Network) 1. It is assumed, for instance, that either one of the printers 4 and 5 is a monochrome printer and the other is a color printer. As shown in FIG. 2, the PC 2 contains a keyboard 22, a mouse 23, a hard disk 24, a display unit 25 and a LAN communication unit 26, connected to a control unit 21 as a control means.

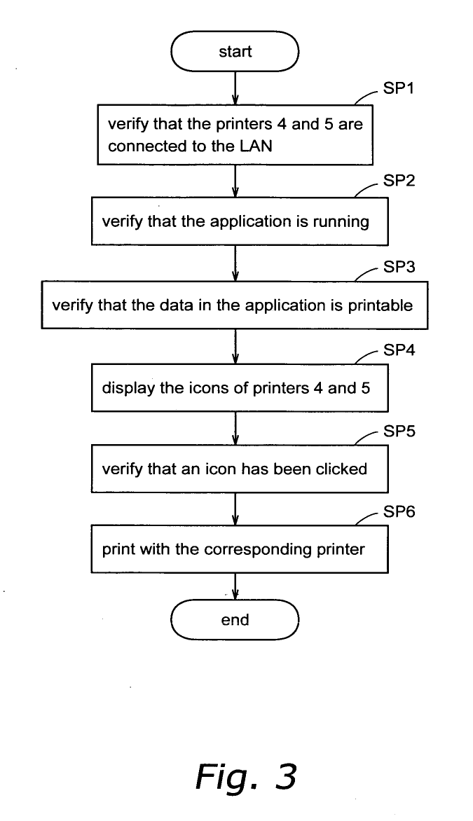

Data entered via the keyboard 22, or data entered via the LAN communication unit 26, is memorized on hard disk 24 as necessary. Driving programs (drivers) for driving each of the two printers 4 and 5 are built into the control unit 21. As shown in FIG. 3, a toolbar 30 is displayed on the display screen of the display unit 25, and an icon 31 corresponding to printer 4 and an icon 32 corresponding to printer 5 are displayed as identification labels on this toolbar 30. The model of the printers 4 and 5, the number of copies, the size of the printing sheet, and the like are pre-set, with correspondence to each of the icons 31 and 32. Note that the icons 31 and 32 may also be displayed on the desktop screen of the display unit 25, and instead of displaying it on the toolbar 30.

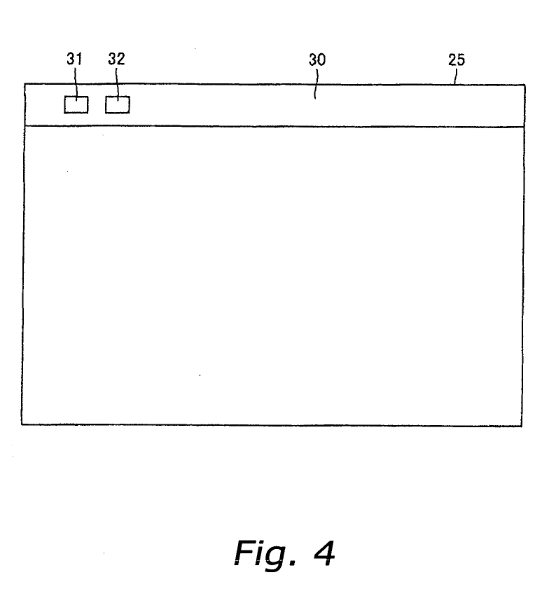

FIG. 3 is a flowchart to explain the working of one embodiment of this invention, and FIG. 4 is a view showing a display screen of a display unit shown in FIG. 2.

First, when an electric power source is supplied, the control unit 21 of the PC 2 verifies in step (abbreviated as SP in the figure) SP1 that the printers 4 and 5 are connected via the LAN 1. The user operates the keyboard 22 and the mouse 23 to launch an application such as, for instance, Word, to display data on the screen of the display unit 25.

The control unit 21 verifies in step SP2 that an application is running, and verifies in step SP3 whether the data in the application is printable on the printers 4 and 5. If printable, in step SP4, icons 31 and 32 corresponding to each of the printers 4 and 5 are displayed on the toolbar 30 of the display unit 25 shown in FIG. 4. If printing is not possible for one of the printers 4 and 5, due to, for instance, being out of printing paper or the like, one of the corresponding icons 31 and 32 is not displayed.

The user operates the mouse 23 to click either of the icons 31 and 32, depending on whether it is monochrome printing or color printing. When the control unit 21 has verified that that one of the icons 31 and 32 has been clicked, it supplies the data to the corresponding printer through the LAN 1 and prints, in step SP6.

Consequently, in this embodiment, since the icons 31 and 32 corresponding to the two printers 4 and 5 are displayed on the toolbar 30 of the display screen, for instance when an application is launched, the user looks at the display and can select any printer to print the data, printing in monochrome or printing in color.

In addition, since the corresponding icon is not displayed for a printer that cannot print, the availability of each printer can be verified easily.

Note that, in addition to a monochrome printer and a color printer as printers 4 and 5, the scope of the application can be widened, such as to a high-speed printer and a low-speed printer, and a printer set to print all the pages of a file displayed on the display unit 25 and a printer set to print the cover only.

In addition, although two icons 31 and 32 are displayed on the toolbar 30 in the above embodiment, the number thereof can be increased according to the number of printers.

In the foregoing, an embodiment of this invention was described with reference to figures; however, this invention is not limited to the illustrated embodiment. Various modifications and variations can be applied to the illustrated embodiment within the same scope as, or an equivalent scope to, this invention.

What is claimed is:

1. A print control process device, which is a print control process device enabling printing by selecting from at least two kinds of printing means, comprising
a display means, and
a control means having built therein driving programs corresponding to each of the at least two kinds of printing means, for displaying on a display screen of the display means identification labels that specify each of the at least two kinds of printing means, and, in response to one of the identification labels having been designated, controlling the corresponding printing means with the corresponding driving program.

2. The print control process device as recited in claim 1, wherein the control means verifies whether printing by the at least two kinds of printing means is possible, and displays only the identification label corresponding to the printing means that has been verified to be able to print.

3. The print control process device as recited in claim 1, wherein the control means displays a print icon on the toolbar of the display screen of the display means as an identification label.

4. The print control process device as recited in claim 1, wherein the at least two kinds of printing means comprise printing means enabling color printing and monochrome printing.

5. The print control process device as recited in claim 1, wherein the at least two kinds of printing means comprise printing means with different printing speeds.
